(19) United States
(12) Patent Application Publication
(10) Pub. No.: US 2017/0227252 A1
(43) Pub. Date: Aug. 10, 2017

(54) TUBING SUPPORT DEVICE

(71) Applicant: Michael Hause, Denton, MD (US)

(72) Inventor: Michael Hause, Denton, MD (US)

(21) Appl. No.: 15/015,284

(22) Filed: Feb. 4, 2016

(51) Int. Cl. F24F 13/32; F24F 5/00; F24J 3/08; F16M 1/00

(52) U.S. Cl. CPC F24F 13/32; F16M 1/00; F24F 5/0046; F24J 3/08; F24F 2005/0057; F24J 2003/087

(57) ABSTRACT

A thermal tubing support device that includes: a horizontal bar, where the horizontal bar includes a first end and second end; side support frame, extending from each end of the horizontal bar; and a base, where the base is attached to the distal end each side support frame. Each side support frame preferably includes two rollers, where the two rollers of each side support removably attaches to each end of the horizontal bar. Further, preferably, the two rollers of each side support attach to the base at opposing corners. The base preferably includes four sides, where two sides of the base include rollers. The thermal tubing support device may further include a support loop attached to the horizontal bar, where the support loop provides a means to support the support device in an elevated position.

### BACKGROUND OF THE INVENTION

Field of Invention

The present invention is a tubing support device used to assist in geothermal HVAC installation.

Description of Related Art

A geothermal HVAC system is a common HVAC system that provides a means to supply heating and cooling to a building typically a residence. The geothermal HVAC system transfers heat to and from the ground in order to supply cooling or heat to a building. This type of system is also referred to as a heat pump or a ground source heat pump system. This system uses a ground heat exchange that exchanges heat from the ground during winter to provide heating for the building and alternatively transfers heat from the building to keep the space cool. This heat exchange system involves the use of tubing in the form of geothermal lines that are installed to accomplish the transfer of heat. Tubing is typically referred to as geothermal lines and can be difficult to install due to the weight associated with the tubing. Further individuals typically have to manually hold the tubing to position it at various angles during installation. As a result, it would be advantageous to have a device that could be used to support the tubing and provide rollers to freely transfer the piping and tubing during installation.

### SUMMARY OF THE INVENTION

The present invention relates to a thermal tubing support device that includes: a horizontal bar, where the horizontal bar includes a first end and second end; side support frame, extending from each end of the horizontal bar; and a base, where the base is attached to the distal end each side support frame. Each side support frame preferably includes two rollers, where the two rollers of each side support removably attaches to each end of the horizontal bar. Further, preferably, the two rollers of each side support attach to the base at opposing corners. The base preferably includes four sides, where two sides of the base include rollers. The thermal tubing support device may further include a support loop attached to the horizontal bar, where the support loop provides a means to support the support device in an elevated position.

### BRIEF DESCRIPTION OF DRAWING

FIG. 1 depicts a thermal tubing support device in accordance with the present invention.

FIG. 2 depicts a front view of the tubing support device in accordance with the present invention.

### DETAILED DESCRIPTION

The present invention relates to a tubing support device in the form of a frame that includes rollers at particular portions to effectively allow the support and the transfer of thermal tubing through the frame while installing a geothermal HVAC system. The present invention includes a frame configuration attached to a top horizontal bar with two supporting sides extending to a four-sided base. The side supports include two rollers that meet at the top horizontal bar and then extend downwardly to two opposing corners of the base. Rollers are also provided along the two sides of the base to allow free movement of thermal tubing through the support device according to the present invention.

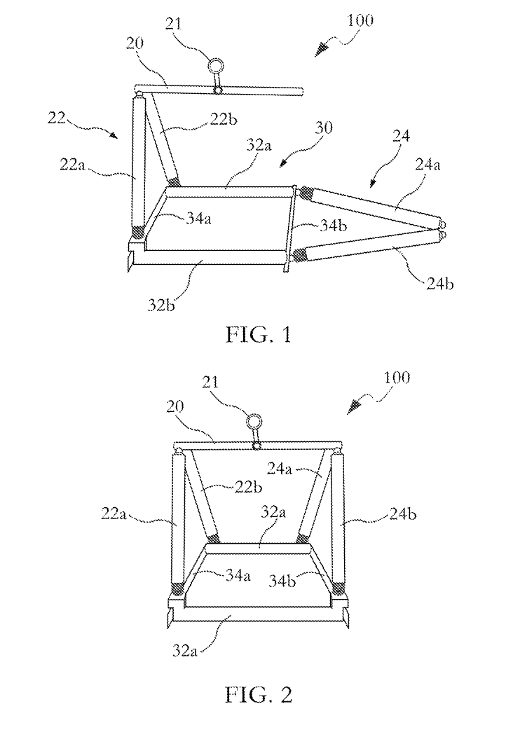

In reference to FIG. 1, a first view of the thermal tubing support Device 100 is depicted. This thermal tubing support device includes a top horizontal Bar 20 that it includes a support Loop 21. The support Loop 21 allows the user to hang and support the support Device 100 on a hook at an elevated position. Extending from each end of the horizontal Bar 20 are side Supports 22, 24. The side Supports 22, 24 extend downwardly to a Base 30 as shown in FIG. 2. FIG. 1 shows Side 24 collapsed and detached from the horizontal Bar 20. This detachment shows the range of movement available for the side Support 24. A similar movement and detachment is available for the side Support 22. Each side support 22, 24 includes rollers. Side Support 22 includes Rollers 22a, 22b that meet at the horizontal Bar 20 and extend to opposite respective corners of the Base 30. Similar rollers are provided for side Support 24, Rollers 24a, 24b. Rollers are also integrated into the Base 30 as shown. Base 30 is substantially square with four sides. Rollers 32a, 32b are positioned on opposing sides and support Bars 34a, 34b are positioned on opposing sides at the Base 30.

Using the thermal tubing support device 100 enables the ability to extend a tubing over Rollers 32a, 32b and through the triangular configuration associated with the side Supports 22, 24. The positioning on the rollers allow the thermal tubing to easily transfer through the supporting device and provides construction workers with a means to support the thermal tubing as opposed to manually manipulating and supporting it during installation. The instant invention has been shown and described in what it considers to be the most practical and preferred embodiments. It is recognized, however, that departures may be made there from within the scope of the invention and that obvious modifications will occur to a person skilled in the art.

1. A thermal tubing support device comprising:
a. a single top horizontal bar, where the top horizontal bar includes a first end and second end;
b. side support frame, extending from each end of the horizontal bar, where each side support frame includes two rollers and the two rollers meet at a point at the end of the horizontal bar;
c. a four sided square base, where the base is attached to the a distal end each side support frame, wherein the base, side support frame and horizontal bar are adapted to create openings for the transfer of thermal tubing there through; and
d. a support loop attached to the horizontal bar, where the support loop provides a means to support the support device in an elevated position.

2. (canceled)

3. The thermal tubing support device according to claim 1, where the two rollers of each side support removably attaches to each end of the horizontal bar.

4. The thermal tubing support device according to claim 2, where the two rollers of each side support attach to the base at opposing corners.

5. (canceled)

6. The thermal tubing support device according to claim 5, where two sides of the base include rollers.

7. (canceled)
